(19) United States
(12) Patent Application Publication
(10) Pub. No.: US 2004/0138901 A1
(43) Pub. Date: Jul. 15, 2004

(54) Remote tourism system and device

(76) Inventor: Michael F. Krieger, Salt Lake City, UT (US)

Correspondence Address: Michael F. Krieger, Kirton & McConkie, 60 East South Temple, 1800 Eagle Gate Tower, Salt Lake City, UT, 84111, US

(21) Appl. No.: 10/342,690

(22) Filed: Jan. 15, 2003

(51) Int. Cl. G06F 17/60

(52) U.S. Cl. 705/1; 705/5

(57) ABSTRACT

A real-time, remotely controlled tourist service is provided which allows individuals to virtually experience the sites, sounds, and culture of a remote location on an individual basis by forwarding instructions to an operator of an audio/video acquisition device so that the viewer may direct the operator to areas and locations which are of interest to the viewer.

### BACKGROUND

While tourism is an opportunity for some to visit other peoples and cultures around the world, the cost of tourism is sometimes prohibitively expensive. As a result, many people participate in the experience vicariously through television programs which describe cultures and events in foreign countries or through the photographs of friends and relatives who visit those countries.

In addition to the financial impediments to tourism, there are also individuals with physical limitations who are not able to travel as extensively as they would like. While television programs are produced to satisfy the general needs of the virtual tourist, there is no freedom for individualization of the experience. For example, if the viewer has a background in science or has an infinity for collecting items or is a hobbyist, then they would be much more interested in the items which are overlooked by the producer attempting to generalize the experience so that it will have appeal to the broadest audience.

### SUMMARY AND OBJECTS OF THE INVENTION

It is therefore an object of some of the embodiments of the present invention to provide a self-directed, near real-time, virtual tour of a remote site.

The present invention provides a near real-time, self-directed virtual tour at the remote site. An image acquisition device such as a digital video camera is either manually operated or placed upon a transportation device such as a car, train, bicycle, or even a robot. The acquisition device also is audio capable and both audio and video data is streamed to an internet site where it can be viewed by many people. The acquisition device is controlled by only one person or a group of people operating cooperatively so that only one set of instructions is given to the operator of the acquisition device.

In use, an appointment would be prearranged whereby the viewer and the operator of the acquisition device could both begin the tour. The viewer through the website then sends movement instructions to the operator of the acquisition device and the tour begins. Through live streaming of video and audio, a viewer experiences the city, countryside, or building by providing specific instructions such as turn left, turn right, zoom in, pan left, pan right, etc. If an item of interest is discovered, the viewer then forwards instructions in near real time to the operator who then follows those instructions to provide an individualized experience for the viewer. Since the audio and video stream is provided to a website, a family may all log onto the same web site from separate locations and enjoy the experience together.

In some embodiments, they may even be able to forward instructions to the operator from several locations, however, these must be coordinated so that conflicting instructions are not sent. Examples of some groups that might like to cooperatively experience the virtual tour would be families who want to revisit a childhood home, a location where they once vacationed together, family grave sites on special occasions, or visits to the hospital when children are born or family members are ill or dying. Under some circumstances, it might be preferable for the operator for the acquisition device to accompany one or more family members in the activity. Under most conditions, however, it is not necessary for anyone but the operator of the acquisition device to be at the location. In an embodiment where a robot operates the acquisition device, no person need be present.

### BRIEF DESCRIPTION OF THE DRAWINGS

In order that the manner in which the above-recited and other advantages and objects of the invention are obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 is an illustration of an operator directing the audio/video acquisition device under the guidance of the viewer.

### DETAILED DESCRIPTION OF THE PREFERRED EMBODIMENTS

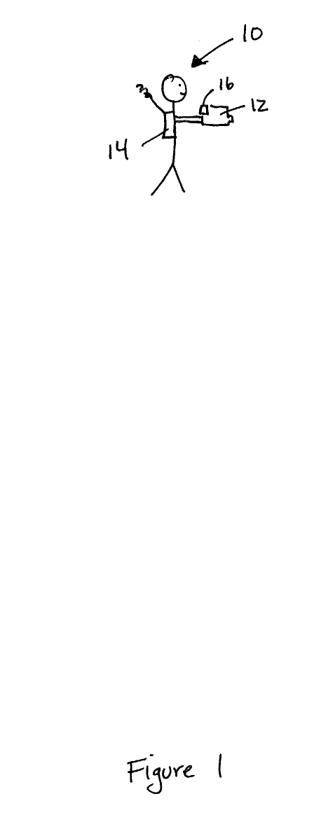

Turning now to FIG. 1, an operator 10 is shown holding an audio/video acquisition device which digitizes images and sounds. On the back of operator 10 is a wireless transceiver 14 which is connected to the audio/video acquisition device 12 to transmit signals acquired by the device to an internet site. Wireless transceiver 14 also receives signals from the site which direct the operator in the movements of audio/video device 12. These directions from the site can be in the form of voice over IP, or may be directions sent from a qwerty keyboard, pen device, touch screen, or some other digital mechanism for conveying directions to operator 10. Both the feed from the acquisition device and the instructions can be conveyed by a wi-fi net hub, satellite uplink, and 802.11 transceiver, cellular transceivers, or other wireless methods known in the art for transceiving signals in near real-time. As used herein, the term “near real-time” means that the signals and instructions are received at the same time they are transmitted, subject only to the lag in the transceiving process. Operator 10 receives these instructions through wireless transceiver 14 and can audibly or visually decipher these on a directional display 16. Directional display 16 is located on the back of audio/video device 12 so that the operator 10 may receive the instructions and audibly or visually perceive those instructions while operating audio/video device 12. The system in which this operator and accompanying device operates anticipates a pool of operators being available in all of the major cities of the world. These operators can be recruited from local student populations or anyone who is willing to be trained in the relatively simple operation of the audio/video device. A viewer contacts the web site and indicates when the viewer would like to take a tour of a particular area. A coordinator then contacts an operator in that area to determine their willingness to be at a designated location at a designated time with the equipment. Once the operator's willingness is verified, a message is then sent to the viewer to verify the appointment. At the prescribed time, the audio/video device 12 is activated and the operator awaits initial instructions. Billing begins on the activation of the audio/video device, and continues for as long as the user is forwarding instructions. When it is necessary for the operator to travel outside of the city for any length of time, an additional travel charge would be assessed.

In one embodiment, the feed from audio/video device 12 may also be recorded at the website and provided to the viewer so that they could relive the virtual tour at a later date. If other individuals wish to view the live stream from audio/video device 12 they can also pay a fee and be given a link to access that portion of the website with the appropriate virtual tour.

In another embodiment, an individual who wishes to browse through the current live feeds, could also pay a fee and view on a per minute basis any of the feeds on the site. It will be appreciated that some of the feeds may be of a personal nature and the general public may not be allowed access to some of the feeds. Other feeds, however, may be interesting to many people and may be viewable by a large audience if they log in and browse through the feeds while that live session is in progress.

It will be appreciated that the present invention will be very useful for physically disabled individuals who wish to relive a pleasant experience of their past by revisiting the site that generated that experience. The present invention will also be used for people for whom the cost of actual travel to the site could be prohibitively expensive.

I claim:

1. A method for a real-time, remotely directed tourist system comprising:
a) an operator;
b) an audio/video acquisition device for gathering a remote data signal;
c) a wireless transceiver for sending the signal from the acquisition device to a website; and
d) means for the operator to receive near real-time movement instructions for operation of the audio/video device from a paying viewer observing on the website the signal from the acquisition device.
